(19) United States
(12) Patent Application Publication
(10) Pub. No.: US 2007/0260987 A1
(43) Pub. Date: Nov. 8, 2007

(54) Selective Displaying of Item Information in Videos

(76) Inventors: James Scott Mohoney, Pacific Palisades, CA (US); Brian Allen Vanyo, Castaic, CA (US); Brian Alex Truong, Cerritos, CA (US); Lee Holt Redmond, Los Angeles, CA (US)

Correspondence Address: MINTZ, LEVIN, COHN, FERRIS, GLOVSKY AND POPEO, P.C, LA JOLLA CENTRE II, 9255 TOWNE CENTRE DRIVE, SUITE 600, SAN DIEGO, CA, 92121-3039, US

(21) Appl. No.: 11/660,872

(22) PCT Filed: Aug. 23, 2004
(86) PCT No.: PCT/US04/27250

§ 371 Date: Feb. 22, 2007

(51) Int. Cl. G11B 27/00

(52) U.S. Cl. 715/723

(57) ABSTRACT

A system and method for associating information with at least one defined is displayed in a visual sequence is disclosed. The method comprises steps or acts of the method comprising: receiving a visual sequence (2001) comprising at least one defined area (2002), identifying associated information (2004) that is associated with the defined area, assigning a unique identifier (4003) relating to the content for the defined area, mapping the associated information with the identifier for the defined area, storing the mapping in a database (2006) and retrieving the associated information via the identifier.

### CROSS-REFERENCE TO RELATED APPLICATIONS

Not applicable.

### STATEMENT REGARDING FEDERALLY SPONSORED-RESEARCH OR DEVELOPMENT

Not applicable.

### INCORPORATION BY REFERENCE OF MATERIAL SUBMITTED ON A COMPACT DISC

Not Applicable.

### FIELD OF THE INVENTION

The invention disclosed broadly relates to the field of information technologies, and more particularly relates to the field of interactive media.

### BACKGROUND OF THE INVENTION

The use of visual displays such as videos or images for commercial purposes is well known. However, in most cases the display of commercial information in an image or video sequence is not welcome or appreciated by a viewer. In most if not all cases the commercial information must be inserted into the images or video stream and the viewer has no choice but to view the commercial information if he or she wishes to view the presentation. New devices called Digital or Personal Video Recorders (DVR, PVR), such as “Tivo®,” have allowed the viewer to record live television and skip over the commercial information, while not interfering with the entertainment. However, these devices are not welcomed by the advertisers, who support the entertainment industry by purchasing time to show their commercial information.

Overlaying information on a video track is also known. See U.S. Pat. No. 6,538,676 issued to Peters in Mar. 25, 2003. However, known solutions require modification of the incoming video sequence to insert the information. There is a need for a video advertising system that does not require modification of an incoming video stream wherein the information is displayed only when a viewer wants to see it.

### SUMMARY OF THE INVENTION

The present invention solves the above-mentioned problems in the art and other problems which will be understood by those skilled in the art upon reading and understanding the present specifications. Briefly, according to an embodiment of the invention a system and method for associating information with at least one defined area displayed in a visual sequence, comprises steps or acts of the method comprising: receiving a visual sequence comprising at least one defined area, identifying associated information that is associated with the defined area, assigning a unique identifier relating to the content for the defined area, mapping the associated information with the identifier for the defined area, storing the mapping in a database and retrieving the associated information via the identifier.

According to another embodiment, a method for reporting selections of defined areas displayed in a visual sequence comprises receiving a signal indicating the selection of an defined area by a user, identifying the selected defined area and storing the selection in a database of selections.

According to another embodiment, a system for associating information with one or more defined areas displayed in a visual sequence comprises a user interface for receiving operator instructions, a processor for determining a key set for at least one of the defined areas and for mapping associated information with the defined area and a database for storing the associated information and a map associating the associated information with the key set.

According to another embodiment, a player system for displaying visual content to a user comprises a display for displaying a series of visual frames showing a defined area, an interface for receiving user selections of defined areas and a processor for constructing a key for a point in the defined area and for looking up associated information, the associated information being associated with the key set of the defined area in a database.

The method can also be implemented as machine executable instructions executed by a programmable information processing system or as hard coded logic in a specialized computing apparatus such as an application-specific integrated circuit (ASIC).

### BRIEF DESCRIPTION OF THE DRAWINGS

FIG. 1 is a simplified block diagram of an information processing system for practicing a method according to an embodiment of the invention.

FIG. 2 is a simplified block diagram of an authoring process according to an embodiment of the invention.

FIG. 3 is a simplified block diagram of a publishing process according to an embodiment of the invention.

FIG. 4 is a simplified block diagram of a player system process according to an embodiment of the invention.

FIG. 5 is a simplified block diagram of a logging system process according to an embodiment of the invention

FIG. 6 is a simplified block diagram of a reporting system process according to an embodiment of the invention

FIG. 7 is an illustration of the system for efficient visualization of unassociated clicks.

FIG. 8 illustrates business system method for monetizing the invention.

FIG. 9 is a screenshot illustrating a player screen.

FIG. 10 is a screenshot illustrating an authoring screen.

### DETAILED DESCRIPTION

In the following detailed description of the preferred embodiments, reference is made to the accompanying drawings which form a part hereof, and in which is shown by way of illustration specific preferred embodiments in which the invention may be practiced. These embodiments are described in sufficient detail to enable persons skilled in the art to practice the invention, and it is to be understood that other embodiments may be utilized and that logical, mechanical and electrical changes may be made without departing from the scope of the present invention. The following detailed description is, therefore, not to be taken in a limiting sense, and the scope of the present invention is defined only by the appended claims.

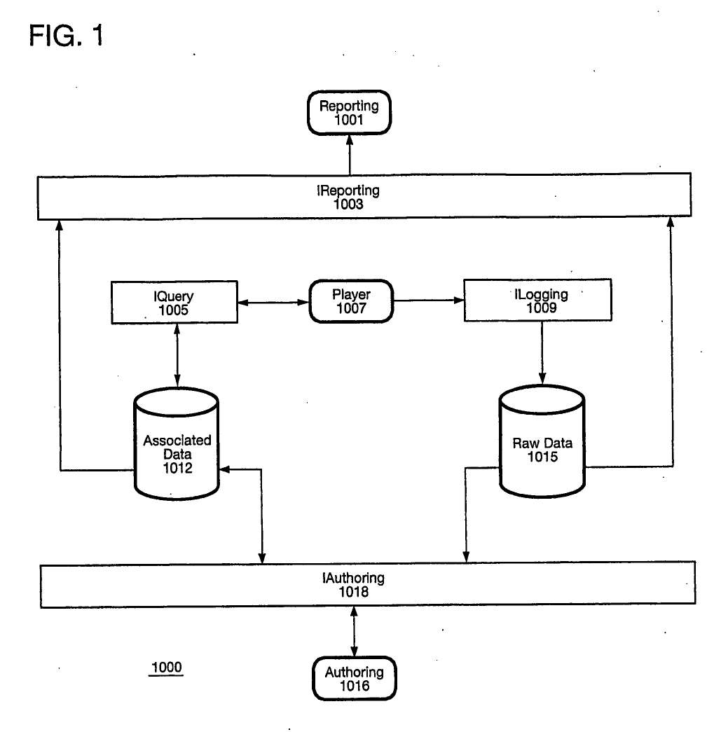

Referring to FIG. 1, we describe a system 1000 for enabling a plurality of information items to be associated with defined areas appearing at specific times in visual media presentations without altering the video media. The associated information can represent actions to be performed. The actions can be invoked either automatically or by a user interacting with the system 1000. At least one region of the screen, or defined areas, is associated with information. Defined areas with associated information will herein be referred to as selectable areas.

Although the system 1000 can work with any form of visual media, for simplicity and example, herein all references to the system 1000 and its components will be made with respect to one possible embodiment of the system: a video sequence being played on a personal computer.

One possible use of system 1000 is to enable information, such as marketing materials, to be associated with products displayed within the video allowing the user to purchase the products by selecting the products thereby invoking the associated actions at the specific places and times within the video where and when the products appear. A possible use of the reporting system is to report geographic and/or demographic and/or sales information for marketing purposes.

In the embodiment discussed herein, a video display system 1000 comprises two general processes: the first is for creating selectable areas in the video sequence, and the other is for invoking the associated actions. These processes will hereafter be referred to as “authoring” 1018 and “player” 1007 processes, respectively. Other processes, herein referred to as the “logging” 1009 and “reporting” 1003 processes, separate and not required for the functioning of the system 1000, collects and reports on information used in the functioning of the player 1007 system, such as user selections.

The system 1000 comprises at least one database. In one embodiment of the present invention, system 1000 comprises two databases. An associations database 1012 is used for storing the associations of keys and their related actions, and a raw data database 1015 for storing the raw information collected in the use of the system 1000 by its users. The blocks 1005 and 1009 represent programmatic interfaces to the databases 1012 and 1015 that comprise logic for processing the information within the respective databases. Blocks 1001, 1007, and 1016 represent the interfaces with which human users interact. The arrows represent the flow of information.

In a computer, a video sequence is normally stored as a group of digital information known as a file. Every file has certain characteristics such as its file name, creation timestamp, and file size that help to identify it on the computer system. Every video sequence has certain characteristics such as file format, codec, and video length that, combined with the file characteristics, can uniquely identify each video sequence to almost certainty. That is, conflicts that arise out of two video sequences having identical characteristics is statistically insignificant. The chances of two different video sequences having identical file and video characteristics can be small enough to be negligible for our purposes.

A video sequence is a series of still images (frames) displayed to the user at a particular rate, for example 30 frames per second for MPEG video to create the appearance of continuous motion. Each frame then occurs at a specific and unique time within the sequence.

Each video frame comprises an array of pixels on a two dimensional grid with axes labeled X and Y. Within each frame, the X and Y coordinate can uniquely identify a pixel. Thus any selectable area represented by a group of pixels can be uniquely specified by a set of X and Y coordinates that encompass its particular shape. Thus any selectable area displayed in a video sequence can be uniquely identified by the union of the video information with the X and Y coordinates. Hereinafter we shall refer to the union of the above information for one pixel as a “key” and for a selectable area as a “key set.” A key set represents multiple keys; one each for each pixel the selectable area encompasses, and can be implemented in any number of ways depending on the geometric scheme used to represent shapes. Since keys can be treated as unique, key sets can act as universal identifiers for selectable areas seen in a given video sequence. These key sets are then used to associate any information with the selectable area in a video sequence without having to embed or alter the video sequence. This information can be stored separate from the video sequence itself (or together with the video sequence). The only requirement is that the system playing back the video sequence must use the same scheme used in the creation of the key sets. Thus, by mapping associated actions to key sets identifying a selectable area a head end does not have to insert the associated information into the video sequence to be transmitted. Instead, a user selects a pixel in a selectable area that is being displayed (e.g., by pointing at it with a pointer and clicking) the key for that pixel is obtained from the user selection action and that key can be used to find the key set that encompasses that key, and that key set can identify associated information that has been mapped to that selectable area in a database such as database 1012.

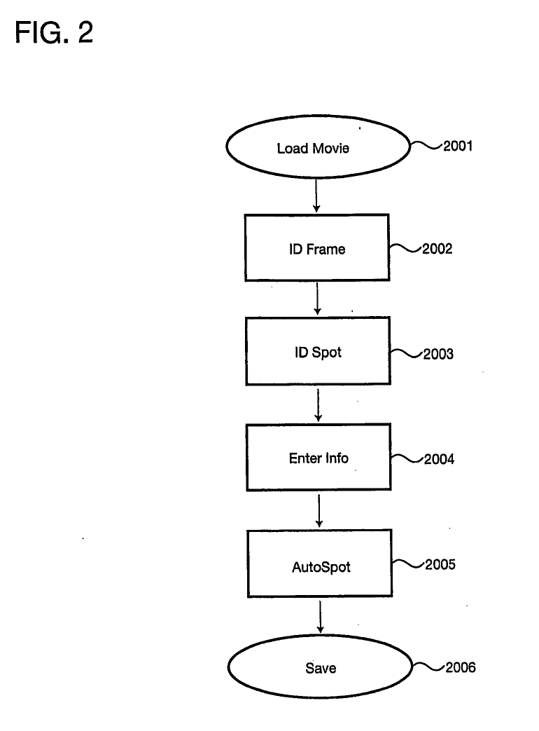

FIG. 2 illustrates the iterative authoring process 1018 comprising loading a movie 2001, choosing (identifying) the frame containing a selectable area 2002, identifying the selectable area 2003, identifying the information to be associated 2004, automatically identifying previous and subsequent occurrences of the selectable area which represent the same selectable area 2005, and saving 2006 the selectable area locally. Step 2001 may comprise loading a DVD master containing a video from a studio or television network preferably into a working memory such as RAM.

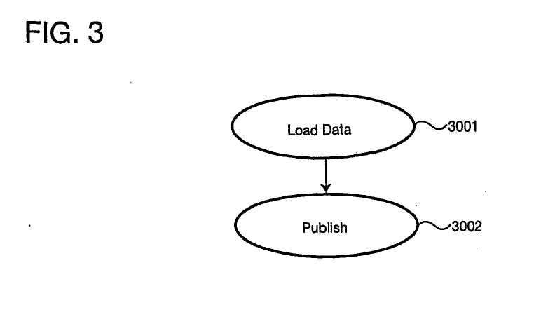

FIG. 3 illustrates the publishing process comprising loading the saved selectable areas 3001 (see step 2006 of FIG. 2 above) and publishing 3002 them to database 1012 for later retrieval.

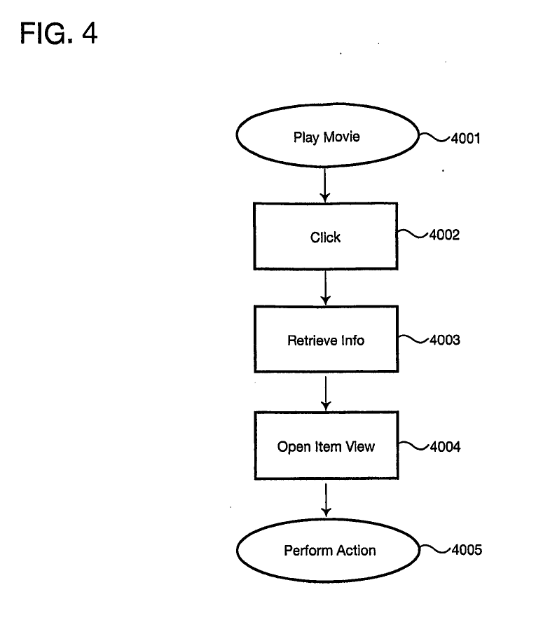

FIG. 4 is a simplified block diagram of a playing process according to one possible embodiment of the invention. The playing process 4001 comprises a video player, preferably a software video player on a computer or a set-top box or a cable television decoder box that contains functionality to allow the viewer to move a pointing device across the video image and to select points within the image currently displayed. When the user wishes to select a selectable area in the video sequence, he/she selects at least one pixel within the selectable area 4002 by clicking thereon. A key is constructed for the pixel using the same algorithm used in the authoring process. This key is then used to look up (or retrieve) any key sets that encompass that key 4003. If one is found, any information associated with that particular key set is returned to the player system. The associated information returned can then be displayed back to the user in any number of ways, such as through an item view window 4004 or performing any action associated with the selectable area 4005. In one embodiment, user-defined preferences for the player 1007 determine the mode of displaying associated information 4004.

A user can select a selectable area by using a pointing device such as a mouse to move a cursor over a selectable area of interest. A selectable area can display a visual indication that there is information associated with it by responding to a flyover by the cursor or to a point and click operation or other equivalent actions. One such indication is a bubble displayed over or near the selectable area to which the user has pointed. The selection can then be made by clicking or other means.

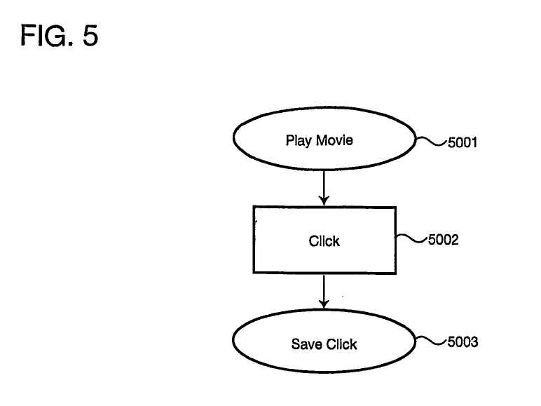

FIG. 5 is a simplified block diagram of a logging process 1009 according to an embodiment of the invention. The player process does not necessarily store any associated information. It sends keys to a database that then looks up any information with those keys. Thus every selection the user makes initiates the sending of information about that selection to the database. If a particular key does not match any key sets, the player system can act accordingly (such as notifying the user of the lack of information on the defined area).

Although not needed after the database lookup of the key or key set has been performed, the user selection is stored by the logging process. This information, along with other information such as demographic or geographic, can be mined at a later time for marketing purposes. The information collected can also be used to create new associations that were not present in the database when the user made their selection.

FIG. 5 illustrates the logging process 1009 according to one possible embodiment of the invention. The process comprises playing a movie 5001, clicking on a selectable area 5002, and saving 5003 the user selection to database 1015 or within the player for transmission at a selected time.

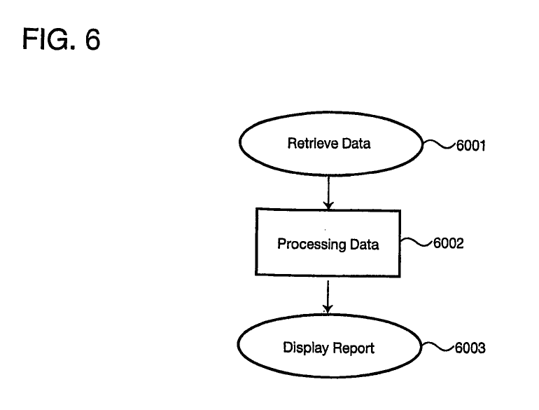

FIG. 6 illustrates a reporting process 1003 according to one possible embodiment of the invention. The process comprises retrieving data 6002 from database 1015, processing the data 6003, and displaying the data to the user 6004. In another embodiment of the present invention, the reporting process 1003 includes transmission of the stored data to a third party, such as the Nielsen service, product marketing companies, etc.

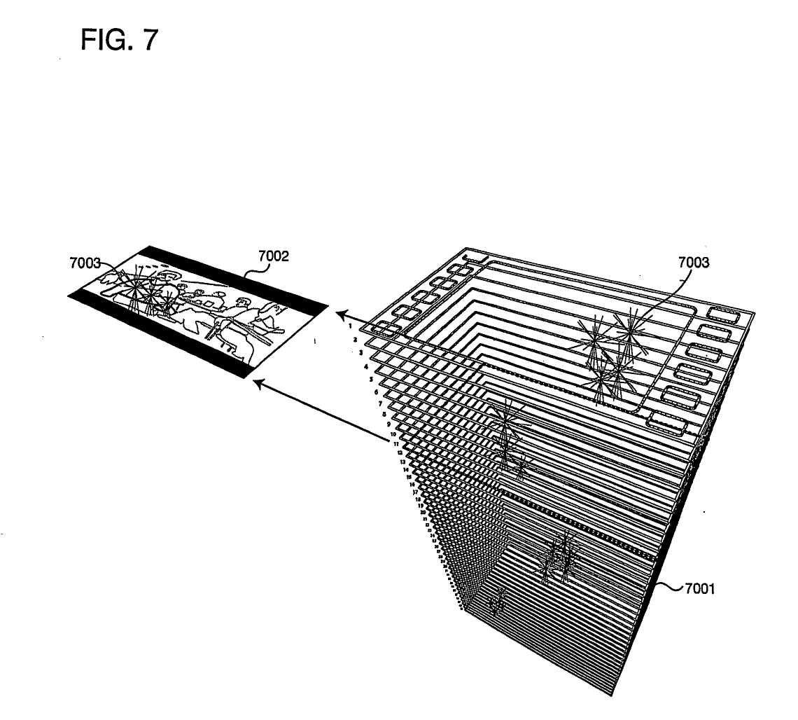

FIG. 7 illustrates a method for viewing user selections in the dimensions of X, Y and T (time). 7001 represents a stack of frames with X being representative of the width, Y being representative of the height and T being representative of the depth. Item 7002 represents an individual frame of media, and item 7003 represents an individual user click. This view allows user selections to be viewed or analyzed with more discrimination in space.

The features of the present invention manage the entire process of product placement for interactive TV, DVD and PC from the vendor/manufacturer to the end user/buyer. The present invention also tracks user viewing habits in real time and is capable of generating a wide diversity of reports about viewer interests, likes and dislikes. As in the case of commercial broadcast television, commercial DVD releases and “streamed” content on the Internet, the use of selectable areas provides a means to defray the cost of creating, obtaining and/or broadcasting, releasing and streaming the content files by charging advertisers for displaying their products or for receiving the user selection data obtained by monitoring user selections.

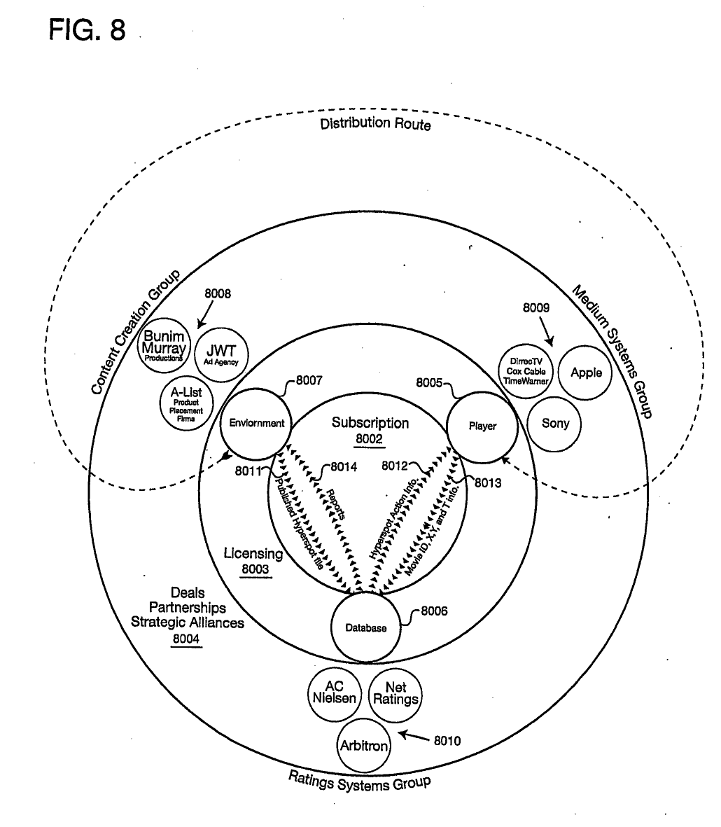

The functionality of the invention's business systems is diagrammed in FIG. 8. The invention can be commercialized in any of the following business models: subscription model 8002; licensing model 4003; deals, partnerships and alliances 8004.

For example, in this embodiment, after the initial authoring of selectable area relationships is complete at point 8007, the data is “published,” via path 8011, to the database 8006. The second path 8013 represents a transmission of movie click coordinate data from the player 8005 to the database 8006, the third transmission of data, 8012, is information sent from the database 8006 to the player 8005 about user choices in the form of actions acted upon by the player 8005. The fourth transmission of data 8014 is information sent from the database 8006 to the operator about distributed movie viewership and movie frame click locations in the form of a visual report such as those discussed above. The path 8013 establishes a subscription fee paid by advertisers, content creators, owners and/or distributors based on quantity of clicks made by viewers per movie. For example, every 1000 clicks (cost per thousand, CPM, is a standard advertising unit) constitutes a higher subscription fee.

Through the use of reports, generated from the database 8006 and transmitted to the author in the environment 8007 by path 8014 an additional or higher subscription fee based upon the number of clicks in path 8013, is to be paid by advertisers, content owners, creators and/or distributors. In other words, the CPM is higher if the data from 8013 is analyzed for marketing or any other purpose.

The second area 8003 represents a licensing model. The licensing model comprises three products. The first is a software program 8007 that an operator uses to apply selectable defined areas over a movie file. The second product is a video player 8005 that records and sends click data to a database 8006 on path 8013, and executes user requested actions returned from the database 8006 on path 8012. The third product is a database 8006 that stores and organizes movie and click data for sale of the demographic data derived from user interaction with the system.

The software program 8007 is licensed to operators 8008 (ad agency, content owners, etc.) under a conventional software end user license. The operator 8008 of the software program 8007 can save selectable area coordinates to a system database 8006 periodically. The software program 8007 can also display and analyze reports sent to it from the database 8006. The fees, usage period, and functionality are determined by the licensor.

The player 8005, being the second product, will be licensed for use by the public. The intent is to have the player 8005 become the dominate player for entertainment media. The player will also be licensed to companies 8009 who want to add selectable area functionality to their current media technology 8001. The fees, usage period, and functionality are determined by the licensor.

The third product, the database 8006, contains huge amounts of data that a ratings company 8010 would like to possess. Access to the database can be licensed to these persons for a fee or royalties based on use. The fees, usage period, and functionality are determined by the licensor.

The area 8004 comprises groups of established companies that would be interested in owning part or all of the system technology. The groups have been organized into three areas. They are: a content creation group 8008, a medium systems group 8009, and the ratings systems group 8010. The present invention can be commercialized as part of set-top boxes or any form of digital media distribution 8001 to the mass television/entertainment audience.

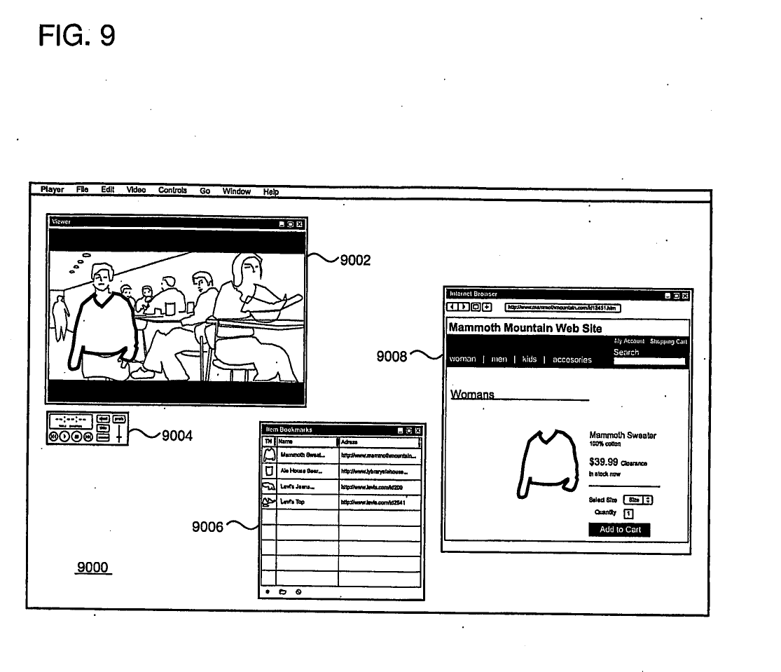

FIG. 9 is a screenshot illustrating a player screen 9000 (see player 1007 of FIG. 1). The player screen 9000 includes a viewer window 9002 that allows a user to view a video or visual sequence or a particular frame or image from a video or visual sequence. The control window 9004 allows the user to stop, play, move forward or move backward the video or visual sequence in viewer 9002. An item bookmarks window 9006 provides a list of items and marketing material information that is associated with selectable areas in the video or visual sequence of the viewer window 9002.

The viewer window 9002 allows a user to view a video or visual sequence and interact with selectable areas in the video or visual sequence. Depending how the player preferences are configured by the user, upon clicking on a selectable area, the Item Bookmarks window 9006 stores and creates a list of user clicked selectable areas. By clicking the stored links in the Items bookmarks window an Internet browser 9008 allows a user to view a web page or web site associated with the selectable area. For example, of a selectable area of viewer window 9002 encompasses a sweater worn by an actor in the video, clicking on the selectable area could spawn the web browser 9008 and immediately display a web site of the store or merchant that sells the sweater online, or create a bookmark for later use in the Items bookmark window.

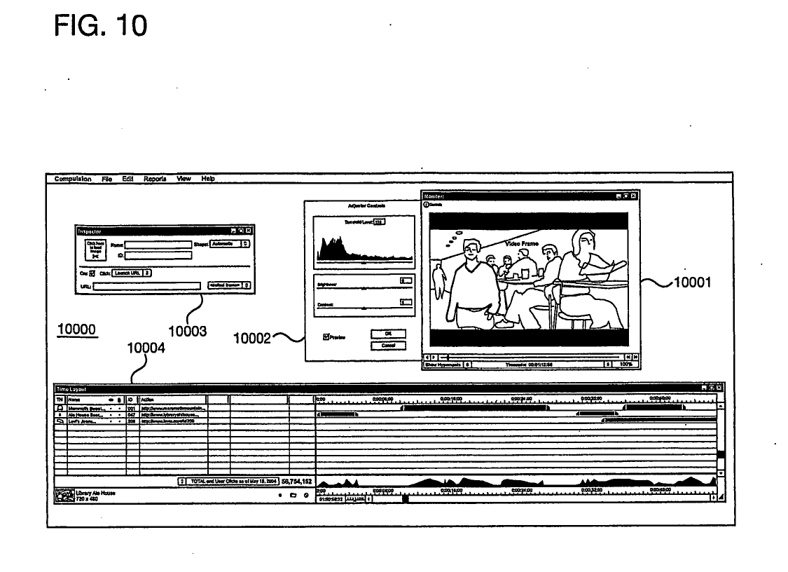

FIG. 10 is a screenshot illustrating an authoring screen 10000 (see authoring 1016 of FIG. 1). The authoring screen 10000 includes a monitor window 10001 that allows a user to view a video or visual sequence or a particular frame or image from a video or visual sequence. The monitor window 10001 allows the user to stop, play, move forward or move backward the video or visual sequence. The adjuster dialog 10002 allows the user to modify the edge detection algorithms. An inspector dialog 10003 allows a user to specify which actions shall be taken when a user clicks on a selectable area and input informative information for the selectable area. A pull down menu in the inspector dialog 10003 allows a user to specify certain actions that are taken as a result of a viewer clicking on a selectable area, such as launching a URL in a web browser.

A time layout window 10004 provides a list of selectable areas in the video or visual sequence of the monitor window 10001 along with the user-specified action taken as a result of clicking on the selectable area and a definition of the times during the video when the selectable area is displayed. The time layout window 10004 further provides, for each selectable area defined and areas without selectable areas defined, a summary of clicks by viewers. This information can be reported in the reporting action 1001 of FIG. 1.

A benefit of the present invention is that it permits creating selectable areas over the video layer without altering the video layer. These selectable areas can be added, deleted or their associated information changed at any time without a re-release of the video. Another benefit of the present invention is that it permits the viewer to interact with the selectable area content placed by the creators of the video at the viewer's discretion. Another benefit of the present invention is that the viewer's selections can be tracked for the purpose of collecting marketing information. These viewer's selections can be tracked regardless of whether they have previously associated information or not. The previously unassociated selections can be used to help define viewer's interests.

Therefore, while there has been described what is presently considered to be the preferred embodiment, it will understood by those skilled in the art that other modifications can be made within the spirit of the invention.

We claim:

1. A method for associating information with at least one defined area displayed in a visual sequence, the method comprising:
receiving a visual sequence comprising at least one defined area;
identifying associated information that is associated with the defined area;
assigning a unique identifier relating to the content for the defined area;
mapping the associated information with the identifier for the defined area;
storing the mapping in a database; and
retrieving the associated information via the identifier.

2. The method of claim 1, wherein the visual sequence comprises a video sequence.

3. The method of claim 1, wherein the mapping comprises storing the unique identifier in a database separate from where the visual sequence is stored and separate from where the associated information is stored.

4. The method of claim 1, wherein the associated information comprises file data.

5. The method of claim 1, wherein the associated information comprises video data.

6. The method of claim 1, wherein the unique identifier comprises information identifying a set of pixels comprising the defined area.

7. The method of claim 1 wherein the associated information comprises actions to be performed by the system.

8. The method of claim 1 wherein the associated information is retrieved at a time subsequent to creation of the association by reconstructing the key.

9. The method of claim 1 further comprising:
displaying a set of frames showing the defined area;
receiving a signal selecting a point in the defined area;
constructing a second unique identifier for the point;
matching the second unique identifier for the point against the unique identifier for the defined area;
retrieving the information associated with the matched unique identifier; and
displaying the associated information responsive to receiving the signal.

10. The method of claim 9, further comprising storing data reflecting the receipt of the signal selecting the defined area.

11. The method of claim 9 further comprising performing actions associated with the defined area.

12. The method of claim 9 wherein constructing a key comprises using file information comprising the coordinates within the frame showing the defined area of the pixels comprised by the defined area.

13. The method of claim 9 further comprising sending a message communicating that there is no associated information when the database does not contain associated information corresponding to the key.

14. A method for reporting selections of defined areas displayed in a visual sequence, the method comprising: displaying a set of images comprising one or more selectable defined areas receiving a signal indicating the selection by a user of one or more of the defined areas; identifying the selected defined area; and storing the selection in a database of selections.

15. The method of claim 14 further comprising logging each selection of a defined area by each of a plurality of users.

16. The method of claim 15 further comprising sending a report of user selections to an interested party.

17. The method of claim 15 further comprising determining which selections have matching keys in the database.

18. The method of claim 16 further comprising grouping the selections that have no matching keys in the database.

19. A system for associating information with one or more defined areas displayed in a visual sequence, the system comprising:
a user interface for receiving operator instructions;
a processor for determining a key set for at least one of the defined areas and for mapping associated information with the defined area; and
a database for storing the associated information and a map associating the associated information with the key set.

20. A player system for displaying visual content to a user, the system comprising:
a display for displaying a series of visual frames showing one or more defined areas;
an interface for receiving user selections of at least one defined area; and
a processor for constructing a key for a point in the at least one defined area and for looking up associated information, the associated information being associated with the key of the at least one defined area.

21. The system of claim 20 further comprising a transmitter for transmitting a report of user selections of defined areas.

22. The system of claim 20 further comprising presenting the associated information to a user responsive to receiving a request for the associated information.

23. A system for associating information with at least one defined area displayed in a visual sequence, the system comprising:
a receiver for receiving a visual sequence comprising at least one defined area;
a processor configured for:
identifying associated information that is associated with the defined area;
assigning a unique identifier relating to the content for the defined area; and
mapping the associated information with the identifier for the defined area;
a memory for storing the mapping in a database; and
a database management system for retrieving the associated information via the identifier.

24. The system of claim 23, wherein the visual sequence comprises a video sequence.

25. A system for reporting selections of defined areas displayed in a visual sequence, the system comprising: a receiver for receiving a signal indicating the selection of an defined area by a user; a processor configured for identifying the selected defined area; and a memory for storing the selection in a database of selections.

26. A system for associating information with at least one defined area displayed in a visual sequence and transmitting the visual sequence to a user, the system comprising:
a receiver for receiving a visual sequence comprising at least one defined area;
a processor configured for:
identifying associated information that is associated with the defined area;
assigning a unique identifier relating to the content for the defined area; and
mapping the associated information with the identifier for the defined area;
a memory for storing the mapping in a database;
a database management system for retrieving the associated information via the identifier;
a display for displaying the visual sequence including the at least one defined area;
an interface for receiving user selections of at least one defined area; and
a processor for constructing a key for a point in the at least one defined area and for looking up associated information, the associated information being associated with the key of the at least one defined area.

27. A method comprising:
displaying a video comprising a sequence of images, the images including a plurality of key sets associated with at least a portion of a corresponding image;
receiving user-generated input selecting a key within one of the key sets;
polling a database to obtain data associated with the key set of the selected key; and
initiating a display of information characterizing the data obtained from the database.
